(19) United States
(12) Patent Application Publication
(10) Pub. No.: US 2006/0224670 A1
(43) Pub. Date: Oct. 5, 2006

(54) File distribution method and client terminal implementing the same

(75) Inventor: Makoto Kubota, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/190,618

(22) Filed: Jul. 27, 2005

(30) Foreign Application Priority Data
Mar. 31, 2005 (JP) 2005-104209

(51) Int. Cl. G06F 15/16

(52) U.S. Cl. 709/204

(57) ABSTRACT

A file distribution method is provided that is suitable for the transfer of files, such as patch files and virus definition files, to be released to an indefinite number of client terminals, and that can reduce the load concentration at a server without adding any extra hardware resources. A P2P group is constructed in advance between a plurality of client terminals. When a query is made from a client terminal to the server 22, if any file needed is released at the server, first a search is conducted through the client terminals in the P2P group for a client terminal holding that file. If a hit is found as a result of the search, the file is acquired from that client terminal. If no hit is found, then the file is acquired from the server.

### BACKGROUND OF THE INVENTION

1. Field of the Invention

The present invention relates to a method for distributing a file from a server to many client terminals over a network, for example, for online updating purposes, and a client terminal implementing the same.

2. Description of the Related Art

From the Web sites of operating system software vendors and browser or other client software vendors, security patches are released periodically, or when the need arises, in order to fix any security holes found after shipment of the software. Further, from the Web sites of anti-virus software vendors, the latest virus definition files are released periodically, or when the need arises, in order to counter newly-found viruses. Users access designated sites manually or automatically to check whether any patch files or the latest virus definition files have been released, and install such files by manually or automatically downloading them. Therefore, immediately after the release of a new patch file or virus definition file, there arises the problem that the server of the file is overloaded with accesses and the server response speed drops.

If the capacity of the file distribution server is to be increased or a mirror site is to be installed in order to alleviate the access overload problem, an extra cost, for the necessary equipment, will occur at the vendor side. Furthermore, even if the capacity is increased, there arises the same problem if accesses exceeding the increased capacity occur.

Another possible solution is to install, between the file distribution server and the client terminals, a cache server that many client terminals can use in common, but this solution is not viable in cases where the validity and up-to-dateness of a file is guaranteed by direct communications between the server and the client terminals and the intervention of a cache server is therefore not permitted. This solution has the further problem that an extra hardware resource, i.e., the cache server, has to be installed.

Japanese Unexamined Patent Publication No. 2003-308268 proposes that, first, the content be forcibly delivered to a predesignated first terminal within a user network and, when a request for the delivery of the content is received from a second terminal in the user network, the content be delivered from the first terminal instead of the server, thereby attempting to reduce the load of the server. If this technique is to be applied to the distribution of a file such as a patch file or a virus definition file to an indefinite number of client terminals, the client terminal that should first receive the file in the user network must be predetermined, and this must be managed at the vendor side, which is not realistic.

P2P technology, such as Gnutella and WinMX, allows file sharing among many client terminals by transferring files between client terminals in a P2P (peer to peer) fashion, eliminating the need to install a specific file server. If this P2P technology is to be applied directly to the distribution of a file such as a patch file or a virus definition file, the server at the vendor side has to be incorporated into this P2P group, which is also not realistic.

### SUMMARY OF THE INVENTION

Accordingly, it is an object of the present invention to provide a file transfer method suitable for the transfer of files to be released to an indefinite number of client terminals, and also provide a client terminal implementing the same.

According to the present invention, there is provided a file distribution method of distributing a file to a plurality of client terminals, comprising: constructing in advance a P2P group that comprises at least some of the plurality of client terminals; sending a request from a first client terminal belonging to the P2P group to a server for the transfer of information concerning files held within the server; when any file indicated in the information transferred from the server is needed, then searching through the client terminals belonging to the P2P group for a second client terminal holding the file;

when a hit is found as a result of the search, then sending a request from the first client terminal to the second client terminal for the transfer of the file; and

when no hit is found as a result of the search, then sending a request from the first client terminal to the server for the transfer of the file.

In the above configuration, only the client terminal that has first attempted to acquire the file in the P2P group accesses the server and downloads the file, and thereafter, the file is transferred within the P2P group; in this way, the load concentration at the server can be alleviated without having to add any extra hardware resources.

Preferably, constructing the P2P group in advance includes constructing a plurality of P2P groups each comprising a plurality of client terminals, the information transferred from the server further includes information concerning the P2P group corresponding to the file, and the search is conducted through the client terminals belonging to the P2P group corresponding to the file determined as being needed.

In this way, the search range is restricted to a specific group of client terminals, so that the load of the client terminals to be searched can be distributed over the client terminals.

### BRIEF DESCRIPTION OF THE DRAWINGS

FIG. 1 is a block diagram of a file transfer system according to a first embodiment of the present invention;

FIG. 2 is a block diagram of a file transfer system according to a second embodiment of the present invention;

FIG. 3 is a block diagram of a file transfer system according to a third embodiment of the present invention; and

FIG. 4 is a block diagram of a file transfer system according to a fourth embodiment of the present invention.

### DESCRIPTION OF THE PREFERRED EMBODIMENTS

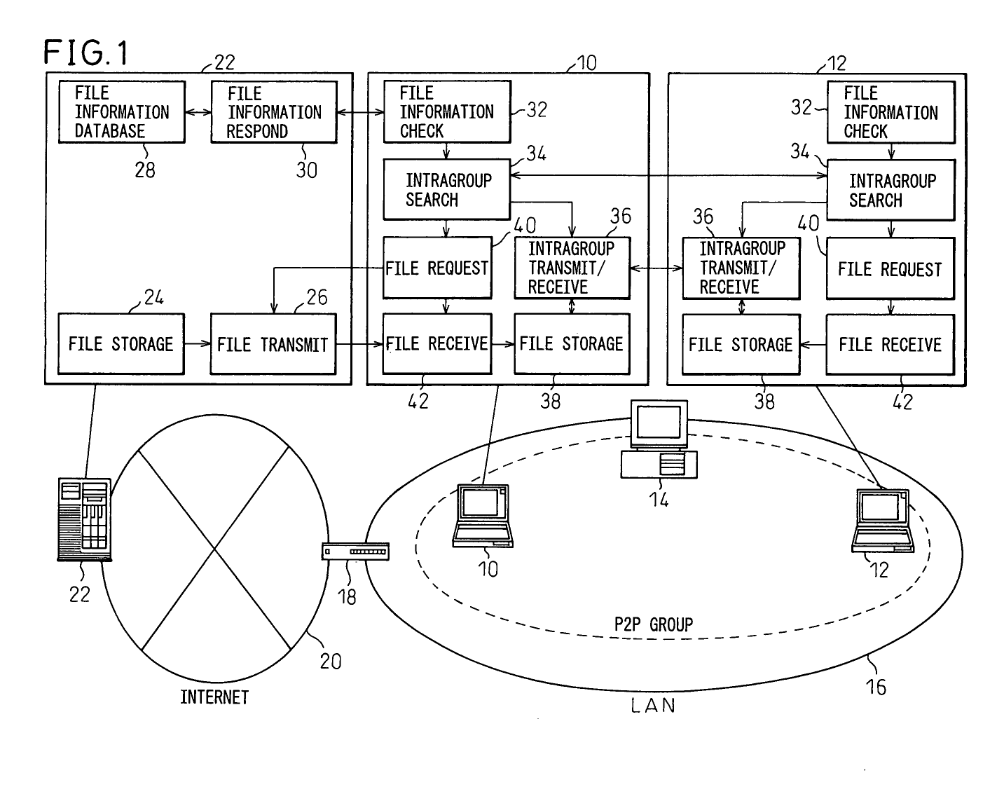

FIG. 1 shows the configuration of a file distribution system according to one embodiment of the present invention.

In FIG. 1, a local area network 16 comprising client networks 10, 12, and 14 is connected to the Internet 20 via a relay device 18. A server 22 for patch file distribution is also connected to the Internet 20. A P2P group is formed between the terminals 10, 12, and 14 by using P2P software that runs on the respective terminals. Firewall software is running on the relay device 18. This firewall is configured to prevent the packets for implementing the functions of the P2P group from flowing out of the LAN 16 into the Internet 20. That is, the P2P group is closed within the LAN 16 and does not extend beyond the relay device 18.

The server 22 comprises: a file transmitting section 26 which transmits a file to a requesting terminal via the Internet 20 by retrieving the file from a file storage section 24 in which patch files are stored; a file information database 28 which stores file information concerning the files stored in the file storage section 24; and a file information responding section 30 which transmits the file information in response to a request from a terminal. The file transmitting section 26, the file information database 28, and the file information responding section 30 are all implemented in software that runs on the server 22.

The client terminals 10, 12, and 14 each comprise: a file information checking section 32 which queries the server 22 for the file information and checks if any file that needs to be applied is released at the server 22; an intragroup searching section 34 which, when any such file is available at the server 22, searches the P2P group for that file by transferring an inquiry between the client terminals, in accordance with P2P technology, to find if any other client terminal holds that file; an intragroup transmitting/receiving section 36 which, when any terminal holding that file is found, performs a peer-to-peer file transfer between the terminals and stores the file in a file storage section 38; a file requesting section 40 which, when it is found as a result of the intragroup searching that there is no terminal within the group that holds the file, then makes a request to the server 22 to transfer the file; and a file receiving section 42 which receives the file transferred in response to the request and stores the file in the file storage section 38. The file information checking section 32, the intragroup searching section 34, the intragroup transmitting/receiving section 36, the file requesting section 40, and the file receiving section 42 are all implemented in software that runs on the client terminal.

In the above configuration, when any of the client terminals 10, 12, and 14, by querying the server 22 manually or automatically by software, knows that a file such as a new patch file or virus definition file has been released, and when the client terminal decides to acquire the file for installation, first the P2P group is searched to find if any other terminal within the same group holds that file and, if any terminal holding that file is found, a request is made to that terminal for the transfer of the file; on the other hand, if there is no terminal holding that file, the request is sent to the server 22. In this way, as only the terminal that first knows about the release of the file in the P2P group sends a file transfer request to the server 22, the load of the server can be reduced without having to add any extra hardware resources.

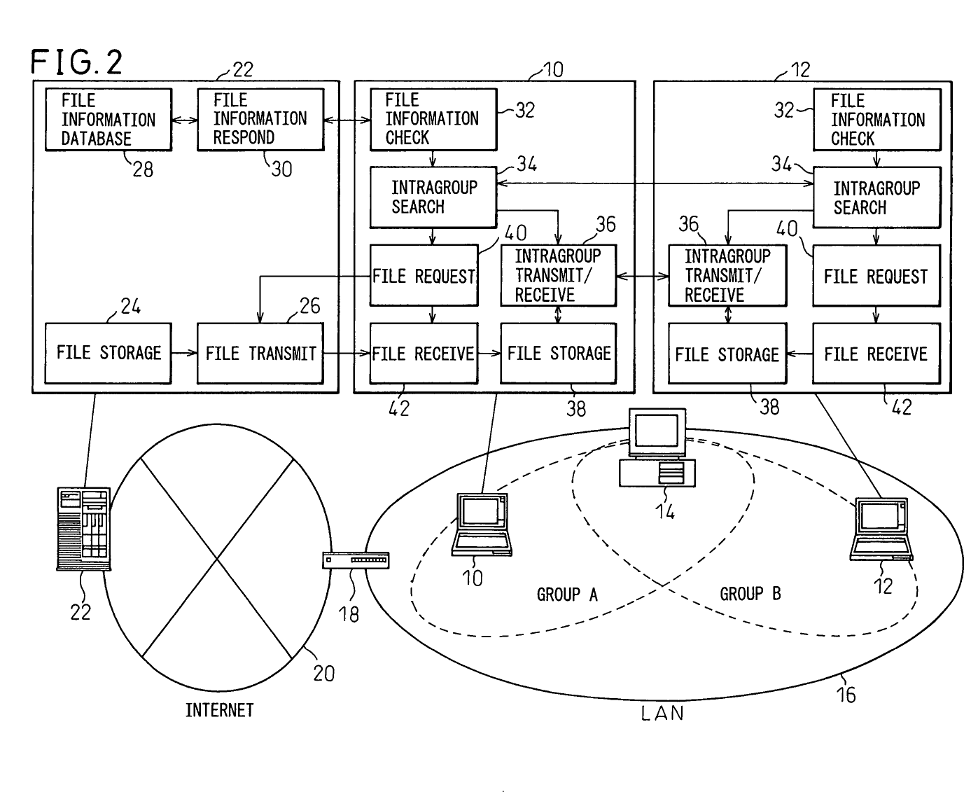

FIG. 2 shows the configuration of a file transfer system according to a second embodiment of the present invention. In FIG. 2, it is assumed that the terminals 10 and 12 are notebook-type client terminals having a poor CPU resource, while the client terminal 14 is a desktop terminal having a relatively good CPU resource. A group A as a first P2P group is formed between the terminals 10 and 14, and a group B as a second P2P group is formed between the terminals 12 and 14. The file information database 28 in the server 22 stores the file information in the format shown in Table 1 below.

TABLE 1
Example of file information

| URGENCY LEVEL | FILE NAME | P2P GROUP NAME |
|---|---|---|
| A | A1 | GROUP A |
| A | A2 | GROUP A |
| B | B1 | GROUP B |

In Table 1, a file with the file name A1 and a file with the file name A2 are the files for the group A, while a file with the file name B1 is the file for the group B. In this example, the group A corresponds to urgency level A, and the group B corresponds to urgency level B.

Known P2P technology, such as WinMX (Version 2.6), that can define a plurality of P2P groups can be used here. With this P2P technology, group ID can be specified, and this ID can also be used as the P2P group name. If the P2P technology used here is one that has provision for the installation of a parent server, the address of the parent server may be used as the P2P group name, or the P2P group name may be defined so as to indicate the file name extension (characters appended at the end of the file name).

In the example shown in FIG. 2, the file sharing group A is constructed of the terminals 10 and 14, and the file sharing group B is constructed of the terminals 12 and 14, by using the above P2P technology. Any terminal newly activated during system operation will participate in either one of these groups in accordance with the mechanism of the P2P technology used.

The way of grouping the terminals is manually set by the administrator of each terminal based, for example, on an instruction from the administrator of the LAN. Further, the administrator makes a judgment and issues an instruction by considering, for example, machine power, length of machine running time (all night or not), physical network configuration, etc. Based on these criteria, the terminals are grouped in such a manner that the terminals judged to be the terminals to which a patch should be applied earlier than the other terminals belong to the group of the higher urgency level and the other terminals belong to the group of the lower urgency level. The above judgment, instruction, and setting may actually be implemented automatically by software.

In the above network and system, file A2 may be newly posted at the server 22 as a patch file of urgency level A (see Table 1). Then, the terminal 14 sends a query to the server 22 from its file information checking section 32 earlier than the other terminals in the LAN 16. The file information checking section 32 holds the name of the previously applied patch file as shown in Table 2 below in the same format as the file information database of Table 1.

TABLE 2
Example of file information held in file
information checking section

| URGENCY LEVEL | FILE NAME | P2P GROUP NAME |
|---|---|---|
| A | A1 | GROUP A |

The server 22 that received the query refers to the file information database 28, and responds to the query by transmitting to the terminal 14 the patch file name and the P2P group name corresponding to the type of the patch. The type here refers to the patch urgency level, and the contents of Table 1 are transmitted in their entirety as the response.

Based on the above response, the terminal 14 determines the patch file to be applied to itself. Here, it is assumed that, of the patch files not yet applied to itself, the terminal 14 desires to have those of urgency level A applied and decides that the patch file with the file name A be applied. In this situation, the intragroup searching section 34 in the terminal 14 conducts a search for that file within the group (group A) corresponding to the reported P2P group name. As, in this case, the result of the search shows no hits, the file requesting section 40 in the terminal 14 makes a request to the server 22 for the transfer of the file; in the server 22, the file transmitting section 26 retrieves the requested file from the file storage section 24 and transmits it to the requesting terminal 14. In the terminal 14, the file receiving section 42 receives the file and stores it in the file storage section 38.

The terminal 10 may send a query to the server 22 for the file information. It is also possible that the terminal 10, like the terminal 14, holds the information shown in Table 2. The server 22 that received the query responds by sending the contents of Table 1. Based on this response, the terminal 10 decides that the patch file with the file name A2 must be applied. Then, the intragroup searching section 34 in the terminal 10 conducts a search for that file within the group (group A) corresponding to the reported P2P group name. As, in this case, the result of the search shows a hit, the intragroup transmitting/receiving section 36 in the terminal 10 receives the patch file A2 from the thus found terminal 14 and stores the file in the file storage section 38.

In the above process, as the terminal 10 downloads the patch file A2 from the terminal 14, the access load on the server 22 can be reduced. Furthermore, as the search range is restricted to the group A in the LAN, it becomes possible to construct a system that provides a faster response for patch file distribution than the prior art system can.

Moreover, in the present embodiment, the P2P group is not constructed only from the poor CPU resource terminals 10 and 12, but each group is constructed by including a good CPU resource terminal 14, and this terminal 14 requests the server 22 for the delivery of the patch earlier than any other terminal does; this serves to reduce the load of each terminal as well as the load of the network by preventing extra traffic from flowing.

In the above description, each group has been set according to the urgency level of the patch file, but instead of using the urgency level as the criterion, each group may be set according to whether the software to which the patch is to be applied, such as the operating system or application program, is already installed or not.

Further, instead of reporting the group name for every file released at the server 22, the group name may be reported only for files larger than a predetermined size, and the file transfer according to the method of the present invention may be performed only for such files, with provisions made so that each terminal downloads any file smaller than that size directly from the server 22.

The file information stored in the file information database 28 within the server 22, and to be returned to the client terminal in response to the query received from the file information checking section 32 in the client terminal, may include file attribute information such as file size, time stamp, and a checksum, in addition to the file name and group name shown in Table 1. Table 3 below shows an example of the information that carries the checksum of each file (the value of the sum of data contained in the file) as the file attribute information.

TABLE 3
Second example of file information

| | | P2P GROUP | |
|---|---|---|---|
| URGENCY LEVEL | FILE NAME | NAME | CHECKSUM |
| A | A1 | GROUP A | chk_a1 |
| A | A2 | GROUP A | chk_a2 |
| B | B1 | GROUP B | chk_b1 |

When the file is acquired from the server 22 or from another client terminal, the checksum value calculated from the data contained in the file is compared with the checksum carried in the file information returned from the server 22 and, if they do not match, the file is discarded by determining that an error has occurred; this makes it possible to address the situation that the file is corrupted for such reasons as communication trouble or alterations made at another terminal.

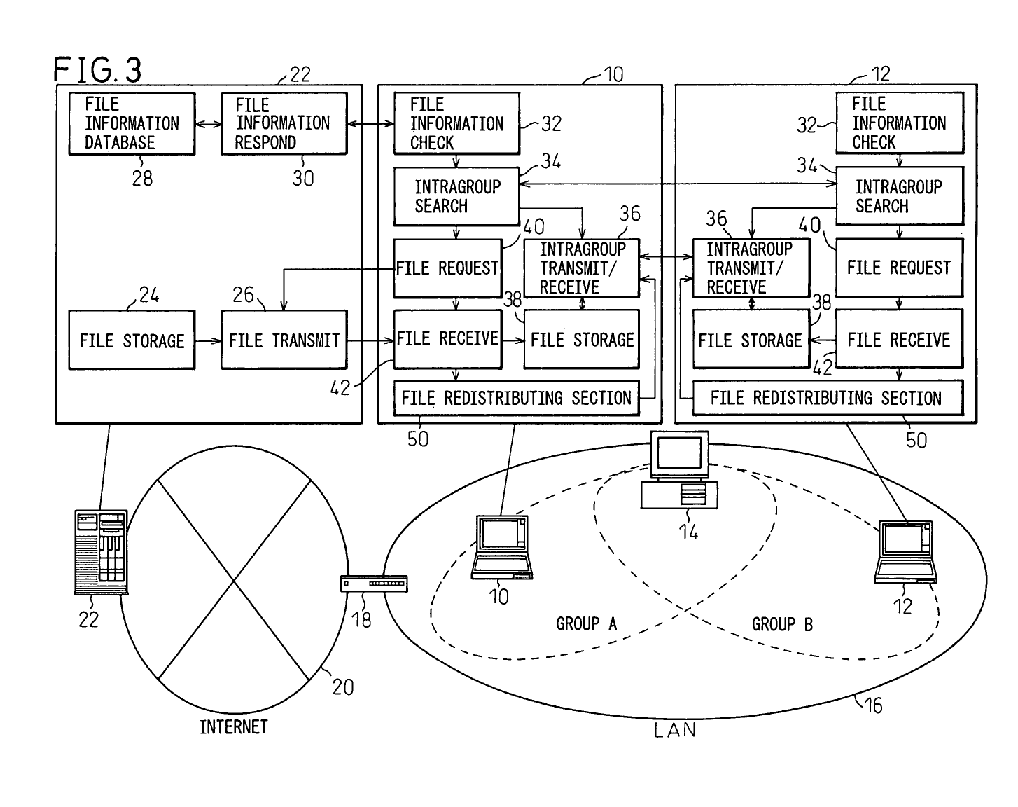

FIG. 3 shows a file transfer system according to a third embodiment of the present invention. The difference from the system of FIG. 2 is that each of the client terminals 10, 12, and 14 includes a file redistribution section 50. The file redistribution section 50 distributes the file downloaded from the server 22, to another client terminal within the same group in accordance with Winny technology which is a P2P technology. The thus redistributed file is further redistributed to another client terminal within the same group in accordance with the Winny technology. Then, at each client terminal, when its intragroup searching section 34 has conducted a search for the file within the group, if it is found that the target file is already stored within its own terminal, then the client terminal uses that file stored within itself. If the target patch file is not stored within itself, the client terminal recognizes that the file stored in another terminal is the target file, and receives the patch file from that other terminal and stores it within itself. Here, the result of the intragroup searching does not always show the result of searching only within its own terminal. That is, the redistribution of the file within the P2P group, after downloading it from the server 22, may not be performed for a long time and, before the redistribution is completed, the result of the intragroup searching may show the result of searching within its own terminal or within another terminal.

Further, the intragroup searching section 34 may perform the intragroup searching in such a manner that first its own terminal is searched for the target patch file and, if it is not found within it, then other terminals are searched for the file.

Furthermore, rather than redistributing the file to all the terminals within the group after downloading it from the server, a query may be sent to each of the other terminals to see if it desires to receive the file by way of redistribution, and the file may be redistributed only to the terminals that desire to receive the file. In this case, each terminal that received the query about the redistribution responds by determining whether it desires to receive the file or not, for example, based on the CPU resource usage at that instant in time.

With the above provision, compared with the case of redistributing the file to all the other terminals, a time difference can be introduced when redistributing the file within the P2P group, and also the file redistribution can be preformed considering the load condition of each terminal; therefore, the system can alleviate the load of each terminal as well as the load concentration in the network.

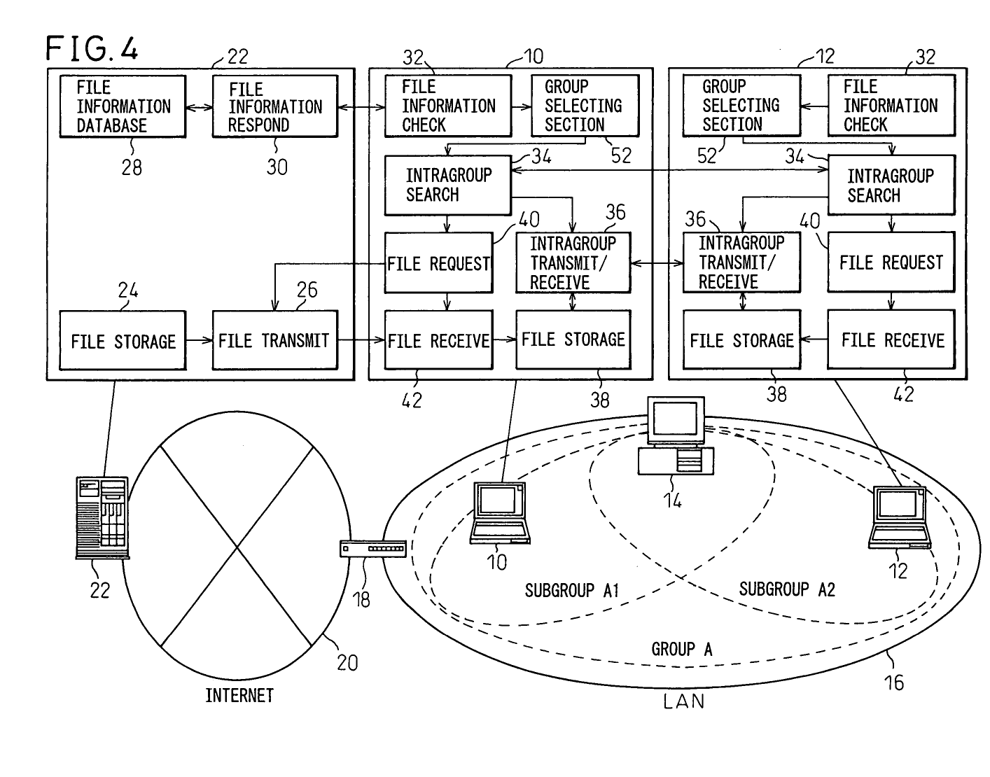

FIG. 4 shows a file transfer system according to a fourth embodiment of the present invention. The differences from the system of FIG. 2 are that a plurality of subgroups are formed between the client terminals forming each P2P group, and that each client terminal includes a group selecting section 52 for selecting one of the plurality of subgroups. In the example shown in FIG. 4, subgroups A1 and A2 are formed within the group A which is one of the P2P groups. When the group name of the file, reported from the server 22 in response to the query from the file information checking section 32, is group A, then the group selecting section 52 selects one of the subgroups A1 and A2, for example, in a round robin fashion, and the intragroup searching section 34 searches the client terminals within the selected subgroup for the file. As the search range is thus restricted to a specific group of client terminals, the load of the client terminals to be searched does not concentrate on a specific terminal but can be distributed over the client terminals.

1. A file distribution method for distributing a file to a plurality of client terminals, comprising:
constructing in advance a P2P group that comprises at least some of said plurality of client terminals;
sending a request from a first client terminal belonging to said P2P group to a server for the transfer of information concerning files held within said server;
searching through the client terminals belonging to said P2P group for a second client terminal holding said file when any file indicated in said information transferred from said server is needed;
sending a request from said first client terminal to said second client terminal for the transfer of said file when a hit is found as a result of said search; and
sending a request from said first client terminal to said server for the transfer of said file when no hit is found as a result of said search.

2. A file distribution method according to claim 1, wherein constructing said P2P group in advance includes constructing a plurality of P2P groups each comprising a plurality of client terminals,
said information transferred from said server further includes information concerning the P2P group corresponding to said file, and
said search is conducted through the client terminals belonging to said P2P group corresponding to said file determined as being needed.

3. A file distribution method according to claim 2, wherein said plurality of P2P groups are constructed according to the degree of urgency with which the client terminals need said file.

4. A file distribution method according to claim 2, wherein said plurality of P2P groups are constructed according to the presence or absence of software to which said file is to be applied.

5. A file distribution method according to claim 1, wherein said information transferred from said server includes attribute information concerning said file, and
a value indicating the validity of said file acquired by said first client terminal is examined based on said attribute information.

6. A file distribution method according to claim 1, further comprising redistributing said file transferred from said server to said first client terminal, to another client terminal within said P2P group.

7. A file distribution method according to claim 6, further comprising sending a query from said first client terminal to the other client terminals in said P2P group as to whether said other client terminals desire to receive said file by way of redistribution, and wherein
said file is redistributed only to the client terminals that desire to receive said file.

8. A file distribution method according to claim 1, wherein said P2P group contains a plurality of P2P subgroups,
said method further comprises selecting one of said plurality of P2P subgroups, and
said search is conducted only through the client terminals belonging to said selected P2P subgroup.

9. A client terminal comprising:
means for constructing a P2P group with other client terminals;
means for requesting a server for the transfer of information concerning files held within said server;
means for searching through the client terminals belonging to said P2P group for a client terminal holding a file that is indicated in said information transferred from said server and that is determined as being needed;
means for acquiring said file from the client terminal found to hold said file as a result of said search; and
means for acquiring said file from said server when no hit is found as a result of said search.

10. A client terminal according to claim 9, wherein said P2P group constructing means is capable of constructing a plurality of P2P groups,
said information transferred from said server further includes information concerning the P2P group corresponding to said file, and
said searching means searches through the client terminals belonging to said P2P group corresponding to said file determined as being needed.

11. A client terminal according to claim 10, wherein said plurality of P2P groups are constructed according to the degree of urgency with which the client terminals need said file.

12. A client terminal according to claim 10, wherein said plurality of P2P groups are constructed according to the presence or absence of software to which said file is to be applied.

13. A client terminal according to claim 9, wherein said information transferred from said server includes attribute information concerning said file, and
said client terminal further comprises means for examining, based on said attribute information, a value indicating the validity of said file acquired from said server or from said client terminal found to hold said file.

14. A client terminal according to claim 9, further comprising means for redistributing said file acquired from said server to another client terminal within said P2P group.

15. A client terminal according to claim 14, further comprising means for sending a query to the other client terminals in said P2P group as to whether said other client terminals desire to receive said file by way of redistribution, and wherein
said redistributing means redistributes said file only to the client terminals that desire to receive said file.

16. A client terminal according to claim 9, wherein said P2P group contains a plurality of P2P subgroups,
said client terminal further comprises means for selecting one of said plurality of P2P subgroups, and
said searching means conducts said search only through the client terminals belonging to said selected P2P subgroup.

17. A program storage device readable by a machine, tangibly embodying a program of instructions executable by the machine to perform method steps for distributing a file to a plurality of client terminals, said method steps comprising:
constructing in advance a P2P group that comprises at least some of said plurality of client terminals;
sending a request from a first client terminal belonging to said P2P group to a server for the transfer of information concerning files held within said server;
when any file indicated in said information transferred from said server is needed, then searching through the client terminals belonging to said P2P group for a second client terminal holding said file;
when a hit is found as a result of said search, then sending a request from said first client terminal to said second client terminal for the transfer of said file; and
when no hit is found as a result of said search, then sending a request from said first client terminal to said server for the transfer of said file.

18. A program storage device according to claim 17, wherein constructing said P2P group in advance includes constructing a plurality of P2P groups each comprising a plurality of client terminals,
said information transferred from said server further includes information concerning the P2P group corresponding to said file, and
said search is conducted, through the client terminals belonging to said P2P group, corresponding to said file determined as being needed.

19. A program storage device according to claim 18, wherein said plurality of P2P groups are constructed according to the degree of urgency with which the client terminals need said file.

20. A program storage device according to claim 18, wherein said plurality of P2P groups are constructed according to the presence or absence of software to which said file is to be applied.

21. A program storage device according to claim 17, wherein said information transferred from said server includes attribute information concerning said file, and
a value indicating the validity of said file acquired by said first client terminal is examined based on said attribute information.

22. A program storage device according to claim 17, further comprising redistributing said file transferred from said server to said first client terminal, to another client terminal within said P2P group.

23. A program storage device according to claim 22, further comprising sending a query from said first client terminal to the other client terminals in said P2P group as to whether said other client terminals desire to receive said file by way of redistribution, and wherein
said file is redistributed only to the client terminals that desire to receive said file.

24. A program storage device according to claim 17, wherein said P2P group contains a plurality of P2P subgroups,
said method steps further comprise selecting one of said plurality of P2P subgroups, and
said search is conducted only through the client terminals belonging to said selected P2P subgroup.
